(19) United States
(12) Patent Application Publication
(10) Pub. No.: US 2010/0300951 A1
(43) Pub. Date: Dec. 2, 2010

(54) Gray Water Recycling System

(76) Inventors: Suzanne Vierling, Spring Valley, CA (US); Martin Vierling, Spring Valley, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/791,825

(22) Filed: Jun. 1, 2010

Related U.S. Application Data
(60) Provisional application No. 61/182,327, filed on May 29, 2009.

(51) Int. Cl. E03C 1/00; C02F 1/00

(52) U.S. Cl. 210/232

(57) ABSTRACT

A gray water reclamation system having a holding tank configured to engage between the drain trap of a conventional sink and the drain conduit leading to the sewer or septic tank. The tank so engaged functions to both capture gray water and to prevent sewer gases from migrating back to the sink drain. An overflow drainpipe provides water communication to the sewer to prevent overflows and a filter and a pump are both operatively engaged to the holding tank, yet positioned for changing and service without draining the holding tank or disengaging the system.

This application claims priority to U.S. Provisional Application No. 61/182,327 filed on May 29, 2009 and is incorporated herein in its entirety by reference.

### BACKGROUND OF THE INVENTION

1. Field of the Invention

The invention disclosed relates generally to the field of water conservation. More particularly, it relates to a system adapted for engagement with conventional under-sink and washing machine drainage systems employed in modern housing. The disclosed device, once installed, provides for a continuous recycling of gray water. The water, so recycled, may be employed for other than potable uses, thereby conserving water, which heretofore was destined for the sewer.

2. Prior Art

In most modern countries the continued supply of a sufficient amount of clean potable water to residents has become an ever more burdensome challenge. With populations increasing and sources of new water decreasing due to climate change, over pumping, drought, and other reasons, water conservation has become more and more important. Every gallon of water conserved or recycled helps maintain or increase the available reservoir of fresh water for drought years as well for increased building in developing areas.

One underemployed source of fresh (non-salt) water over the last few decades is that of gray water. Gray water is conventionally defined as water which is initially employed for a household or an industrial use. Subsequent to this first use, the water is then allowed to empty down the drain pipes of wash basins, tubs, and showers or through drain pipes from washing machines and the like. Such water is minimally polluted since it has only been used for washing or rinsing of the occupants themselves or such things as dishes or laundry.

Conventionally, gray water has been simply discarded and communicated from the user's water outlet pipe into a sewer line or septic tank line. As a consequence, this minimally employed and rarely polluted source of fresh water, from a sink or tub or washing machine located in the user's residence, is lost to both the resident and the municipal water provider once it flows down the drain. Due to ever increasing water shortages from drought or temporary or permanent climate changes, and the increased cost of transporting water to users in more recent times, there exists an ever increasing need to employ every gallon of fresh water to its fullest potential.

Consequently, the discarding gray water which can easily be employed for tasks such as landscape watering, toilet flushing or car washing and the like, is a practice which is being revamped and must continually be reviewed for change. As such, gray water conservation and reuse is a practice that is increasing in favor amongst the public and water providers alike. In some communities where there are severe shortages, gray water recycling is destined to eventually become required.

Conventional recycling systems typically attempt to minimally filter the gray water and direct it via a pump or gravity to a holding tank. From the reservoir in the holding tank, the water may be employed for secondary use in place of the normally employed potable water which is required for drinking and cooking and the like. Water for landscaping, cleaning, car washing and other non-drinking purposes may all employ stored gray water rather than the more valuable supply of potable water.

However, despite their great utility, conventional gray water recycling systems while being able to greatly decrease a household's water consumption, are generally very complicated to install as a retrofit to a house or building due to plumbing and electrical requirements, and conventionally gray water recycling systems are not installed in new construction.

A gray water recycling system would be much more deployable if the system were adapted to utilize as many existing, standard components as possible. Further, and most importantly, the system should require minimal modification of the existing plumbing at the venue where it is to be installed. The simplification of installation and commonality of parts and function will serve to encourage installation by homeowners and businesses alike. This is because simple installation and maintenance encourages use by do-it-yourself home and business owners because their smaller water bills will make the minimal requirements for installation seem like it is worth the effort.

An additional concern, regarding conventional gray water recycling systems, is the actual capture and storage of the gray water so captured. The space underneath modern plumbing fixtures like kitchen and bathroom sinks is very limited. In addition to physical limitations, such spaces are conventionally occupied by trash receptacles, other containers, household cleaning products and the like. In laundry areas of most homes, the space for storage is frequently exposed as well as limited. Consequently, to be easily accepted by users, a gray water recapture system must be easily installed and occupy a minimum amount of valuable interior space in the home or building.

Still further, many such gray water recapture systems, in addition to being complicated to install, also lack an easily changed and configured means to filter incoming water to prevent clogging. Of further concern in expanding the sale and installation of such conventionally available systems is the pumping of the stored water. If a pump is required, the failure to provide an easy means for access and replacement of the pump and other parts, renders the entire system hard to service and therefor very expensive to the owner to have serviced.

As such, there exists an unmet need for a gray water recycling system which is easy to install for the novice and professional alike, and thus encourages user employment due to decreased costs for the initial installation. Such a gray water recapture system should also be easy to engage with the drains of conventional sink and washing machine plumbing systems. Such a system should additionally provide easy means of access to the working components for filtration and cleaning so that repair costs are kept low. Finally, such a system, additionally, should provide for easy maintenance and replacement of electrical pumping components without removal of the entire system from its sealed and watertight engagement with household and building plumbing fixtures. This is because every such removal and reinstallation not only incenses service charges, but also increases the chances for subsequent water leaks and water damage to the nearby structure therefrom.

### SUMMARY OF THE INVENTION

The disclosed gray water recycling system herein provides a means to overcome the above noted shortcomings of the conventionally available gray water recycling systems. The system herein disclosed is compact and easy to install. Further, and as noted, of great importance, the disclosed system herein is easily serviced. As a consequence of this easy installation and subsequent servicing, the disclosed water recycling system will encourage widespread use at a time when such use is becoming ever more desirable in order to conserve dwindling water resources.

The system as herein disclosed features a holding tank which is adapted to easily engage with the drain trap, which is employed on virtually all plumbed sinks. Conventional drain traps feature a U-shaped drain pipe between the discharge pipe leading to the sewer and the incoming drain from the sink above.

This type of trap is employed to position and maintain a portion of drained water within the drain pipe as a means to interrupt direct gas communication through the drain from the sewer and ultimately to the sink. The reason for this water block is to prevent unpleasant and potentially harmful gases from the sewer system from leaching into the residence or business. The drain trap also serves useful in catching the occasional accidental dropping of items into the drain which might otherwise end up in the sewer. Many a wedding or engagement ring has been spared an untimely deposit into the sewer, by such drain traps operatively positioned in the drain from a sink.

The device herein features a plumbing fitting adapted to engage the upper end of the storage tank and to communicate with the incoming drain from the sink, thus making it easily user-installable. An overflow drainpipe is provided which is configured for engagement to an outflow pipe leading to the sewer. This overflow engagement provides a means to prevent flooding and water damage should the holding tank become too full and overflow.

A pump is engaged to the device herein, preferably to the exterior of the water storage tank, and has a water inlet communicating with a bottom level of the storage tank. The water outlet from the pump may lead to a larger secondary storage tank or directly to the home or business landscaping if no such tank is available. The pump is removably engaged to the exterior of the storage tank and thus made easily serviceable and replaceable without having to disconnect the reservoir tank from the house or building drain pipes.

Also provided, is a filter element positioned between the incoming water from the inlet pipe leading from the sink, and the top of the outlet pipe. This positioning places the filter above the highest water level in the holding tank and allows the filter to be translated out of the holding tank for cleaning or inspection while the system remains in operation.

An additional embodiment of the device employs a vertically configured holding tank adapted for positioning adjacent to a washing machine, for instance between the washer and dryer or between a washer and a service sink into which it drains. This washer-configured mode of the device also employs the exterior engaged pump and a translatable filter positioned above the maximum water level in the storage tank. In this configuration the system would be especially easy to install since it only needs to provide an inlet aperture for the washing machine drain hose and an outlet for water from the pump such as a hose or plastic pipe leading to a storage tank or yard landscaping.

With respect to the above description, before explaining at least one preferred embodiment of the disclosed gray water recycling apparatus, it is to be understood that the invention is not limited in its application to the details of operation nor the arrangement of the components or steps in the method set forth in the following description or illustrations in the drawings. The various methods of implementation and operation of the disclosed gray water recycling system which is adapted for easy engagement to conventional plumbing fixtures, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based, may readily be utilized as a basis for designing of methods and systems for carrying out the several purposes of the present invention which provides for the recapture of gray water through an easily installed storage tank and pumping system. Therefore, the objects and claims herein should be regarded as including such equivalent construction, steps, and methodology insofar as they do not depart from the spirit and scope of the present invention.

Further objectives of this invention will be brought out in the following part of the specification wherein detailed description is for the purpose of fully disclosing the invention without placing limitations thereon.

It is an object of this invention to provide a gray water recapturing system which is configured for an easy engagement to existing house and business drain plumbing in homes and buildings.

It is another object of this invention to provide such a system which may easily be positioned in a sealed engagement between a sink and the sewer by the sealed communication of a holding tank to the trap portion of conventional drain plumbing.

Yet another object of the device and method herein is to provide such a holding tank which may remain in such an engagement to drain plumbing but has a serviceable exterior pump thereon.

It is another object of this invention, to provide a mode of the storage tank device herein which is adapted for engagement to a washing machine in the narrow confines of a laundry room.

These together with other objects and advantages which become subsequently apparent reside in the details of the construction and operation of gray water recapturing system herein as more fully hereinafter described and claimed, reference being had to the accompanying drawings forming a part thereof, wherein like numerals refer to like parts throughout.

### BRIEF DESCRIPTION OF DRAWING FIGURE

FIG. 1 depicts a perspective view of the device showing its configuring to be positioned in place of the drain trap under a sink and having an exterior serviceable pump and translatable filter drawer.

FIG. 2 depicts a cut away view through the side of FIG. 1.

FIG. 3 depicts a conventional sink with a water trap between the drains leading from both sinks to a conduit leading to the sewer system or septic tank.

FIG. 4 shows a side cutaway view of the device herein engaged in place of the water trap portion of the conventional drain and providing for water capturing as well as prevention of gas flow from the sewer to the sink drain.

FIG. 5 depicts a mode of the disclosed device showing a vertically disposed storage tank having a configuration well adapted for engagement to a washing machine drain hose.

### DETAILED DESCRIPTION OF THE PREFERRED EMBODIMENTS OF THE INVENTION

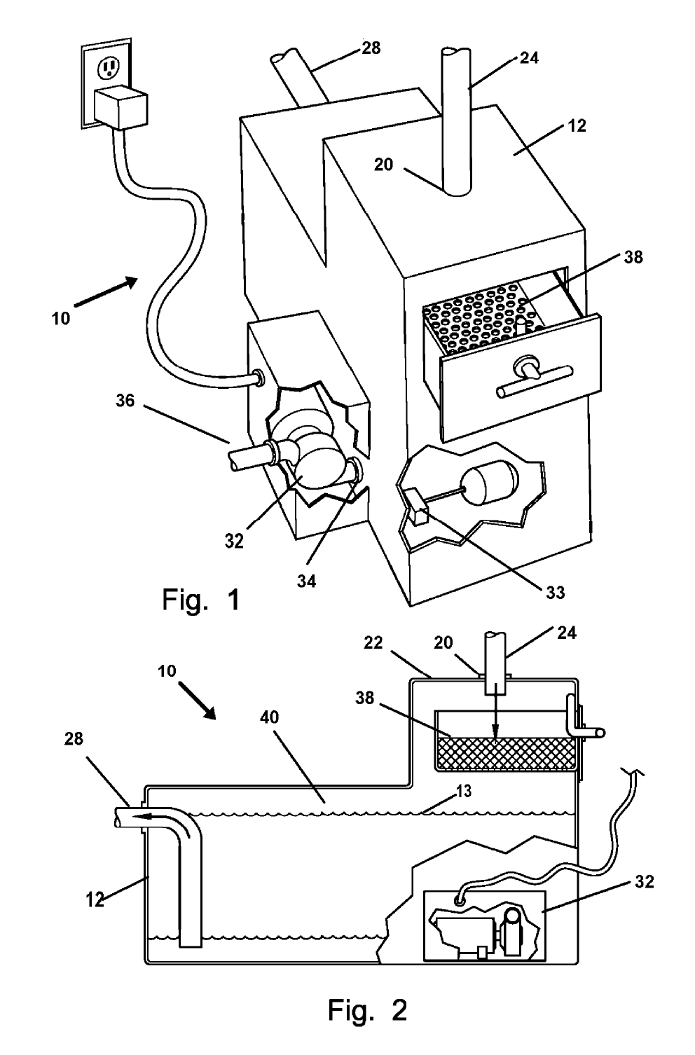

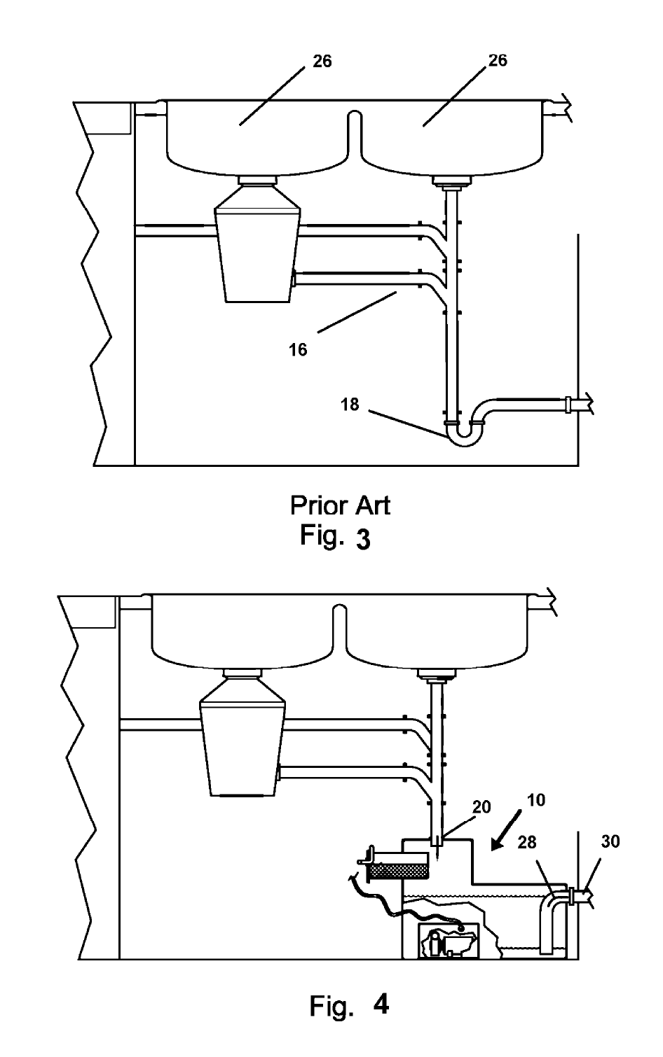

Referring now to the FIGS. 1-5, the system 10 herein disclosed provides a holding tank 12 which is specifically configured for an engagement to the conventional sink drainage system 16 conventionally shown in FIG. 3 in place of the trap 18. The system 10 so engaged, will function to both capture water and prevent sewer gases from migrating to the sink drain.

The device 10 herein features a fitting 20 configured to engage the upper end of the storage tank with the distal end of the incoming drain 24 from the sink 26. Thus the user need only remove the trap 18 and engage the incoming drain 24 in a sealed communication with the holding tank 12, thereby rendering it easily installed. An overflow drainpipe 28 is provided and configured to provide a sealed engagement to the outflow pipe 30 of the house or business plumbing and leading to the sewer. This overflow pipe 28 communicating between the holding tank 12 and the sewer system thereby provides a means to prevent flooding in the event of an overflow of the holding tank 12 since the holding tank 12 will not overflow before excess water is communicated to the sewer.

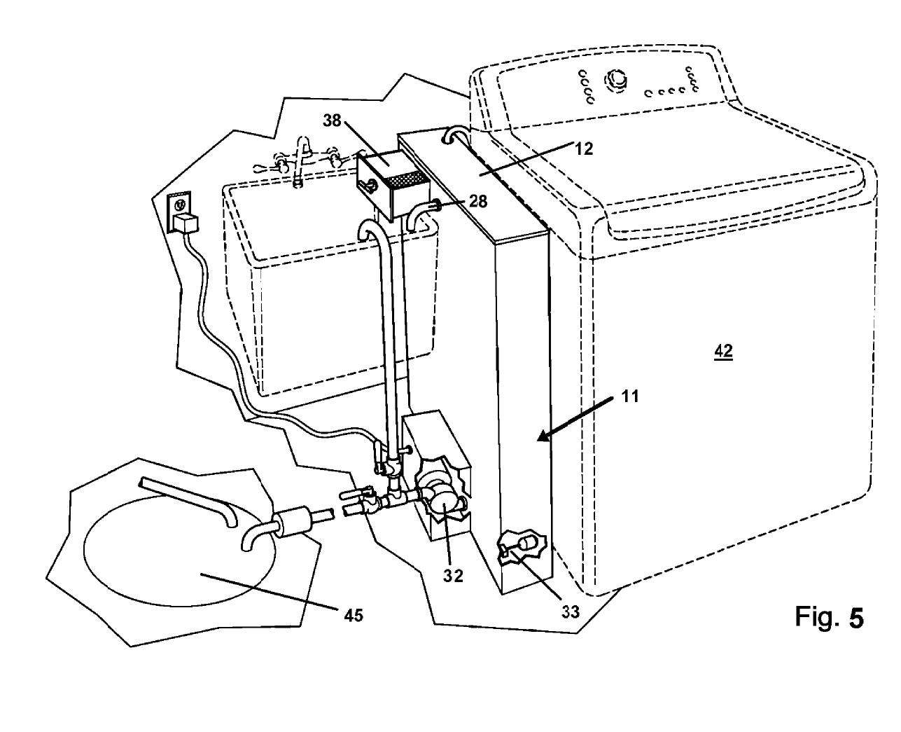

A pump 32 is engaged preferably on the exterior of the holding tank 12 and has an inlet 34 communicating with a lower or bottom level of the interior of the holding tank 12. The outlet 36 from the pump 32 communicates to a secondary storage tank 45 (FIG. 5) or directly to the surrounding landscaping, if no such secondary tank 45 is available. The pump 32 is configured for removal from the exterior of the holding tank 12, without uninstalling the holding tank 12 from the incoming drain 24 or the outflow pipe 30. This allows the device 10 to remain in position and to communicate water from the sink to the sewer, even if the pump 32 fails. It also allows for easy servicing to replace a pump should it be required. A means to interrupt electrical power to the pump 32 is included for instance in the form of a float switch 33. Of course electronic or other means to break the circuit and cease pump operation may be employed and are anticipated and are considered within the scope of this application. The float switch 33 or other circuit interrupt means, opens the circuit providing power to the pump 32 should the water level fall below a predetermined norm to thereby prevent damage to the pump 32.

A filter element 38 is positioned in an upper level 13 above the water level dictated by the overflow pipe 28 held in the holding tank 12. The filter element 38 is thus positioned to filter the incoming water from the inlet pipe 24 leading from the sink 26, and the top of the outlet pipe 28. This positioning places the filter element 38 above the highest water level 40 in the upper level 13 of the holding tank 12, and thereby allows the filter element 38 to be removed from the holding tank 12, for cleaning or inspection with the water still in the holding tank 12 and without disabling the draining of the sink.

Another preferred mode of the device 11 employs a vertically configured holding tank 12 configured for positioning in the narrow spaces adjacent to a washing machine 42. This washer configured mode of the device 11 features the exterior engaged pump 32 and a translatable filter 38 positioned above the maximum water level in the same fashion as above whereby the filter may be changed or serviced while the washing machine still drains. Generally the dimensions of this mode of the device 11 would have the width of the holding tank 12 be twelve inches or less and have a height equal or less than forty two inches which is conventionally equal to or less than the height of a conventional washing machine 42. This allows the device 11 to be placed in the cramped space of laundry rooms.

While all of the fundamental characteristics and features of the gray water capture and recycling system herein have been shown and described with reference to particular embodiments thereof, a latitude of modifications, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A gray water capture and recycling system adapted for engagement to an installed position between a sink drain pipe and an outflow pipe communicating with a sewer or cesspool, comprising:
a holding tank, said holding tank having an internal cavity defined by a sidewall surrounding said internal cavity and a top wall and a bottom wall;
a drain inlet, a first end of said drain inlet configured for a sealed engagement to said sink drain pipe leading from a sink, a second end of said drain inlet having a sealed communication with said internal cavity of said holding tank;
an outlet conduit, a first end of said outlet conduit configured for a sealed engagement with said outflow pipe, a second end of said outlet conduit having a sealed engagement with said internal cavity of said holding tank;
said second end of said outlet conduit positioned to communicate water rising past a maximum level in said internal cavity, to said out outflow pipe;
said second end of said outlet conduit, so positioned, providing means to prevent an overflow of said water from said holding tank;
said water within said internal cavity providing means to prevent gases communicated to said outflow pipe from said sewer or cesspool, from a communication through said sink drain;
a filter, said filter engaged through said sidewall of said tank at an operating position in-between said second end of said drain inlet, and said internal cavity wherein all water communicated from said sink is filtered by said filter before being communicated to said internal cavity;
said operating position being above said maximum level of said water in said internal cavity whereby said filter is removable through said sidewall without draining said internal cavity of water; and
means to communicate water held within said internal cavity to a secondary tank or conduit, whereby water communicated through said filter from said sink to said internal cavity is removed from said internal cavity to allow additional water to be deposited therein.

2. The gray water capture and recycling system of claim 1 wherein said means to communicate water held within said internal cavity is a pump.

3. The gray water capture and recycling system of claim 2 additionally comprising:
said pump having a mounting position exterior to said internal cavity;
said pump having a inlet conduit in a sealed communication with said internal cavity;
said pump having an outlet conduit in sealed communication with said secondary tank or conduit; and
said pump being removable from said mounting position without disengaging said holding tank from said sealed communication with said drain inlet and said outlet conduit whereby said means to prevent gases communicated to said outflow pipe from said sewer or cesspool, from a communication through said sink drain is maintained while said pump is removed.

4. The gray water capture and recycling system of claim 1 additionally comprising:
said filter being removable and replaceable by a translation of said filter through said sidewall in which it is engaged at said operating position; and
said filter being removable from said operating position without disengaging said holding tank from said sealed communication with said drain inlet and said outlet conduit whereby said means to prevent gases communicated to said outflow pipe from said sewer or cesspool, from a communication through said sink drain is maintained while said filter is removed.

5. The gray water capture and recycling system of claim 2 additionally comprising:
said filter being removable and replaceable by a translation of said filter through said sidewall in which it is engaged at said operating position; and
said filter being removable from said operating position without disengaging said holding tank from said sealed communication with said drain inlet and said outlet conduit whereby said means to prevent gases communicated to said outflow pipe from said sewer or cesspool, from a communication through said sink drain is maintained while said filter is removed.

6. The gray water capture and recycling system of claim 3 additionally comprising:
said filter being removable and replaceable by a translation of said filter through said sidewall in which it is engaged at said operating position; and
said filter being removable from said operating position without disengaging said holding tank from said sealed communication with said drain inlet and said outlet conduit whereby said means to prevent gases communicated to said outflow pipe from said sewer or cesspool, from a communication through said sink drain is maintained, while said filter is removed.

7. The gray water capture and recycling system of claim 1 additionally comprising:
said sidewall surrounding said internal cavity defining a width of said holding tank, said width being equal to or less than 12 inches, whereby said holding tank is dimensioned to fit in a narrow space between a washing machine and a wall or a dryer.
